(19) United States
(12) Patent Application Publication
(10) Pub. No.: US 2010/0100489 A1
(43) Pub. Date: Apr. 22, 2010

(54) VARIABLE DURATION WARRANTY TRACKING SYSTEM AND METHOD

(76) Inventors: Rob Chase, Vancouver (CA); Byron Jung, Burnaby (CA); Trevor Wiebe, Vancouver (CA)

Correspondence Address: KNOBBE MARTENS OLSON & BEAR LLP, 2040 MAIN STREET, FOURTEENTH FLOOR, IRVINE, CA, 92614, US

(21) Appl. No.: 12/581,081

(22) Filed: Oct. 16, 2009

Related U.S. Application Data
(60) Provisional application No. 61/106,496, filed on Oct. 17, 2008.

(51) Int. Cl. G06Q 10/00

(52) U.S. Cl. 705/302

(57) ABSTRACT

A warranty management system manages a plurality of variable duration warranties in which predefined but temporally unpredictable events trigger changes in warranty duration.

### CROSS-REFERENCE TO RELATED APPLICATIONS

This application claims the benefit of U.S. Provisional Patent Application No. 61/106,496 filed Oct. 17, 2008, priority from the filing date of which is claimed under 35 U.S.C. §119, and which is hereby fully incorporated by reference.

### BACKGROUND OF THE INVENTION

1. Technical Field

The claimed subject matter relates to devices, systems and methods useful for the tracking of warranties on products and/or services. More specifically, the subject matter relates to a computer-implemented system allowing a consumer to determine the status of a complex-rule warranty and a provider to determine whether and when a payment to the consumer should be made.

2. Background

In some typical cases, a warranty is provided for a fixed period of time following the purchase or first use of a product. For example, a one year warranty is provided by manufacturers of electronic goods. In other typical cases, a warranty is given for a predefined amount of usage of a product, such as the use of a car for 100,000 km. In other cases, warranties can be given for interruption of service. These could, for example, provide consumers with compensation for every day or part of day for which electricity is not delivered to their homes. Another type of warranty could be that a pizza is delivered to your home within a certain time, failing which its price will be reduced.

With some of the above warranties, additional conditions may apply, such as refraining from user-attempted repair or carrying out proper maintenance. In each case, the duration of the warranty is fixed and it is relatively straightforward to monitor it.

In an example more closely related to the currently disclosed subject matter, a warranty may be given to purchasers of electronic device tracking software, which allows devices to be tracked and recovered in the case of theft. In this example, a warranty is given that, if stolen, an electronic device will be recovered within a fixed amount of time, otherwise a payment to the consumer will be made. One of the problems with having a fixed warranty period is that recovery can normally only commence after the thief provides an internet connection to the stolen device, which may occur at any time. While the recovery process after internet connection is more often controllable than not, and can be completed within a relatively short amount of time, there is no control over the actions of the thief and when he connects the device to the internet. The probability with which a thief connects to the internet is generally spread over a longer time period than the typical recovery period. Communication methods other than internet may be used, such as SMS messaging, which still require the thief to position the laptop such that a signal can be sent and/or received.

An example of an existing system related to the background is disclosed in U.S. Pat. No. 6,453,255, which describes a system for calculating guarantee offers for complex products comprising multiple components, each with its separate risk factor. U.S. Patent Application Publication No. 2006/0095289 describes a system and method which allows a customer to log in and check the status of a warranty.

There is a need for a further system which allows consumers to track complex warranties, and in particular, warranties which have durations depending on events outside the control of the consumer and the warranty provider.

### SUMMARY

This summary is not an extensive overview intended to delineate the scope of the subject matter that is described and claimed herein. The summary presents aspects of the subject matter in a simplified form to provide a basic understanding thereof, as a prelude to the detailed description that is presented below.

The subject matter described herein provides a system and method for managing temporally flexible warranty durations. The warranties that are managed by the system are those for which the period of warranty can change depending on one or more events. A product or service provider who has sold a warranty to a consumer can use the system to check the expiry date of a specific warranty and can automate communications to consumers as and/or when the warranty status changes, and can also automate the decision as to paying out on the warranty. A customer who has purchased a warranty or goods carrying a warranty and who possibly needs to make a claim can check the status of the warranty by accessing the system via the internet.

An example of a warranty suitable for such a management system is one that is given for recovering stolen electronic devices, such as laptop computers. If an electronic device is stolen, such a warranty provides that the device will be recovered within, say two months, following the device's first post-theft call into a monitoring centre. If it is not recovered in this period, a payout to the consumer will be made. However, the warranty also allows for the device to first call in any time up to eight months following the report of the theft. As a result, the actual warranty duration may be anything from two months to ten months.

An advantage of having a variable duration warranty is that consumers whose stolen electronic devices call in soon after being stolen can receive payouts at the earliest possible time if the devices are not recovered. Another advantage is that an equally fair chance of recovery is given to consumers whose electronic devices first call in long after being stolen. An advantage for warranty providers is that the number of open warranty files can be kept to a minimum. For example, some files can be closed earlier than others when it is considered that the likelihood of recovery has become negligibly low. Advantages of having a computer implemented system to manage such warranties include the reduction of human error, the saving of time, the facility for consumers to check warranty status at any time, and automatic notification of status changes. Embodiments having one or more of these advantages are described in more detail below.

In one embodiment, the system for managing a plurality of warranties comprises a computer system comprised of a single physical computer or multiple physical computers that interact (e.g. over a local or wide area network) to accomplish a result, and configured to: (a) receive notification of the theft of an electronic device, (b) define an expiry date of a warranty by adding a first predetermined duration to the date of receipt of said notification, (c) receive a call from said electronic device, and (d) redefine the expiry date by adding a second predetermined duration to the date of said call.

### BRIEF DESCRIPTION OF THE DRAWINGS

For a fuller understanding of the nature and advantages of the disclosed subject matter, as well as the preferred mode of use thereof, reference should be made to the detailed description, read in conjunction with the accompanying drawings. In the drawings, like reference numerals designate like or similar parts or steps. For illustrative purposes only, the host that is stolen is shown in the drawings and in the following detailed description as a laptop computer.

FIG. 1 is a probability distribution graph illustrating exemplary probability curves for the first post-theft call and recoveries for different call times;

FIG. 2 is a schematic functional block diagram of a system in accordance with an embodiment of the disclosed subject matter;

FIG. 3 is a functional flow diagram schematically representing the flow process of a system in accordance with an embodiment of the disclosed subject matter;

FIG. 4 is a functional flow diagram schematically representing the extended flow process of a system in accordance with an alternate embodiment of the disclosed subject matter;

FIG. 5 is a swim lane diagram illustrating the daily functionality of the system of FIG. 3; and,

FIG. 6 is a swim lane diagram illustrating the daily functionality of the system of FIG. 4.

### DETAILED DESCRIPTION OF THE PREFERRED EMBODIMENTS

### Terminology

Agent—As used herein, is a software, hardware or firmware agent that is ideally persistent and stealthy, and that resides in a host device. The agent provides servicing functions which require communication with a remote computer system server. The agent is ideally tamper resistant and/or can self-repair, and may be enabled for supporting and/or providing various services such as data delete, firewall protection, data encryption, location tracking, message notification, and software deployment and updates. An illustrative embodiment of an agent is found in the commercially available product Computrace Agent™. The technology underlying the Computrace Agent™ has been disclosed and patented in the U.S. and other countries, which patents have been commonly assigned to Absolute Software Corporation. See, for example, U.S. Pat. Nos. 5,715,174; 5,764,892; 5,802,280; 6,244,758; 6,269,392; 6,300,863; and 6,507,914; and related foreign patents. Details of the persistent function of an agent are disclosed in U.S. Patent Application Publication Nos. US2005/0216757 and US2006/0272020. The technical disclosures of these documents are fully incorporated by reference as if fully set forth herein. It is feasible to use an equivalent agent to the Computrace Agent™, or less preferably an alternative agent with less functionality. For the purposes of the present disclosure, the minimal functional attributes of the agent are to facilitate communications between the electronic device and a monitoring center. Communications may be initiated by the agent, by the monitoring center, or by both.

Host—The term “host” refers herein to an electronic device carrying programming or data. The host may be any electronic device with a memory (such as a laptop computer, personal computer, cell phone, PDA, smart phone (e.g. Blackberry®, iPhone®), personal media device (e.g. iPod®), gaming device, or memory module) that can hold data and/or program(s). It is for the recovery of the host that a warranty is provided, the warranty being of variable duration depending on certain criteria.

Monitoring Center—This is a computer system server (i.e. a single physical computer or multiple physical computers that interact over, for example, a local or wide area network, to accomplish a result) that the agent communicates with or sends a message to. For example, provided an internet connection is available to the host, an agent may communicate over a wireless and/or wired network with the monitoring center once a day (or at some other selected suitable interval, randomly or semi-randomly) to report the location of the host and download software upgrades if there are any. Rather than providing the location, the signals from the host may be analyzed to enable the location to be deduced, for example via triangulation.

Customer Center—This is preferably a web-based interface through which a user may interact with the warranty management system disclosed herein. Such a user may be the legitimate user of a host, the owner of a host or the IT administrator for a group of hosts owned by a company. The customer centre may include a telephone operator so that customers without internet access may phone in.

Theft File—This is a file or record in a database that is created in the warranty management system of the monitoring centre when a customer reports the theft of a host machine via the Customer Centre. The theft file can be Active or Inactive, depending on whether the recovery of the host is in progress or not.

Recovery Guarantee (RG) File—This is a file or a record in a database containing details of a warranty. It includes one or more of an identification of the host, the customer, an eligibility status, an expiry date and a lifecycle status. A recovery guarantee file is created on receipt from a customer of a theft report.

Eligibility Status (ES)—The eligibility status of a customer to a payout for a particular host is kept track of using five status indicators. These are “P” for pending files that are newly created following a theft report; “W” for waiting for the submission of proof of purchase and claim form; “D” for files for which payment is declined; “A” for files for which payment has been approved; and “X” for files for which the theft file is cancelled or closed. A theft file may be closed because it is an erroneous theft report, the customer has located the host, the agent is not installed, or the customer requests that the file be closed.

Lifecycle status—The recovery guarantee file is given a lifecycle status which can be Active, Hold or Closed. This facilitates the implementation of the system. The lifecycle status of a new file is initially Active, but during periods when the duration of the warranty needs to be extended by a variable amount, the lifecycle status is set to Hold. After the maximum extension of time, the lifecycle status is set back to Active. At the end of the lifecycle of the recovery guarantee file, when the eligibility status has been set to “A” or “D” and payments have been processed or rejection letters sent out, the lifecycle status is set to Closed.

Guarantee Expiry Date (GED)—The date that the warranty expires. Depending on events, the expiry date may be changed. This date represents the date by which a stolen device is expected to be recovered by.

Submission Expiry Date (SED)—The date by which a valid claim should be submitted by the customer. This date is relevant if a stolen device is not recovered by the GED.

The detailed descriptions are presented largely in terms of methods or processes, symbolic representations of operations, functionalities and features of the invention. These method descriptions and representations are the means used by those skilled in the art to most effectively convey the substance of their work to others skilled in the art. A software implemented method or process is here, and generally, conceived to be a self-consistent sequence of steps leading to a desired result. These steps involve physical manipulations of physical quantities. Often, but not necessarily, these quantities take the form of electrical or magnetic signals capable of being stored, transferred, combined, compared, and otherwise manipulated. It will be further appreciated that the line between hardware, software and firmware is not always sharp, it being understood by those skilled in the art that software implemented processes may be embodied in hardware, firmware, or software, in the form of coded instructions such as in microcode and/or in stored programming instructions. Unless otherwise indicated, singular elements may be plural and vice versa with no loss of generality.

### Exemplary Embodiment

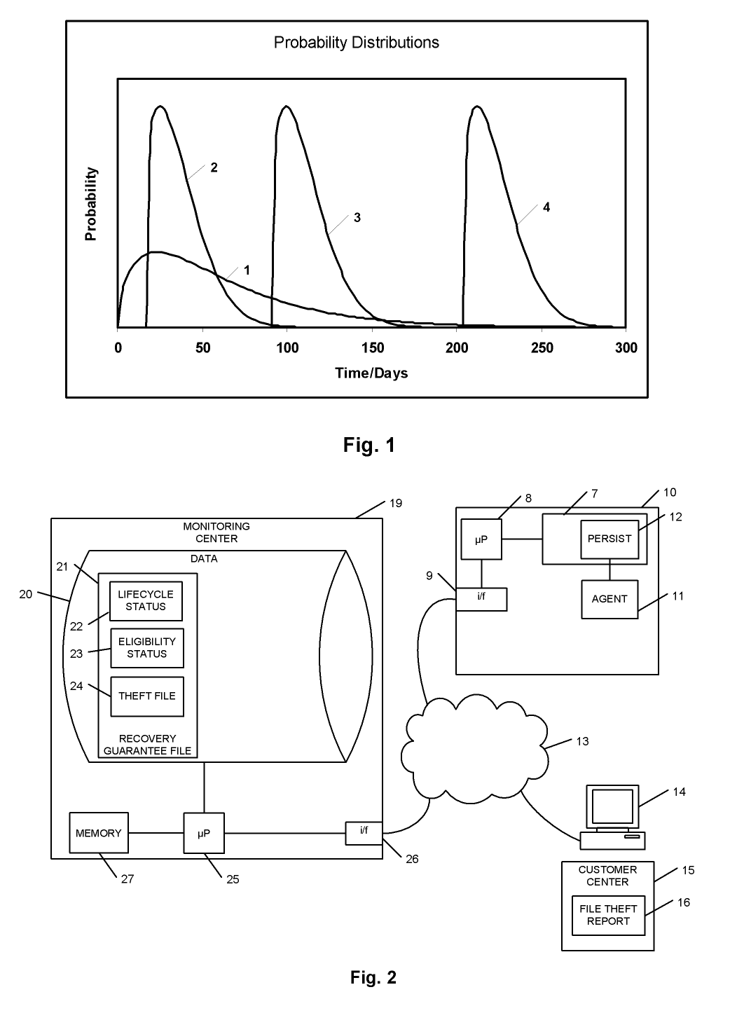

FIG. 1 is a graph illustrating an exemplary probability distribution 1 of a stolen laptop making a call into the monitoring center. The horizontal axis represents the number of days after the theft and the vertical axis represents the probability that a call is first made on a given day following the theft. The exact shape of the curve is not important, and it may change over time as the habits of laptop thieves change, or as technology improves.

Curves 2, 3 and 4 of FIG. 1 show the probability distributions for three stolen laptops being recovered following the first post-theft call of each, where in each case, the first post-theft call occurs a different number of days following the theft. For example, the first laptop calls in about 18 days after its theft, the second after about 90 days, and the third after about 205 days. The curves are essentially the same shape and size, and represent the overall effectiveness of recovery, i.e. the average combined effectiveness of tracking software, recovery personnel and law enforcement officers. In practice, the curves may vary somewhat with the timing of the first post-theft call. To note, once a laptop has called in to a monitoring centre, its recovery is likely to occur in a considerably shorter timeframe than the timeframe in which laptops in general are likely to make their first call.

Defining the end of the warranty period once a laptop has called in, and extending it if it hasn't called in, allows for the efficient resolution and optimum management of open warranty files.

FIG. 2 a schematic functional block diagram illustrating an exemplary embodiment of a system incorporating the subject matter disclosed herein. A laptop 10 includes an agent 11 which is responsible for communicating with and providing location information to a monitoring centre 19. The agent may be supported by a persistence module 12 located on BIOS 7 so that the agent may be repaired or replaced in case of damage. The agent 11 is operably connected to a microprocessor 8 in the laptop 10, which is operably connected to an interface 9 for communication through a network 13 to the monitoring centre 19. The network 13 may, for example, be the internet, a telecommunications network, or a combination of the two. Communication signals pass from the network 13 through the interface 26 of the monitoring centre. The monitoring centre computer system may contain or comprise a server or multiple servers, each having a microprocessor 25 and an electronic memory 27 (or other type of computer-readable medium) carrying computer readable instructions for the processor 25 to carry out. The computer readable instructions define at least part of the functionality of the disclosed subject matter. Also in the monitoring centre is an electronic memory, comprising a database 20 of stored files. An example of a stored record, or file, is a recovery guarantee (RG) file 21, which comprises a record of its lifecycle status 22, the eligibility status (ES) 23 and the theft file 24.

A customer who has suffered the theft of a laptop can report the theft via a terminal 14 connected to the network 13. For example, the terminal 14 may display a web page 15 with a form 16 for entering the details of the theft.

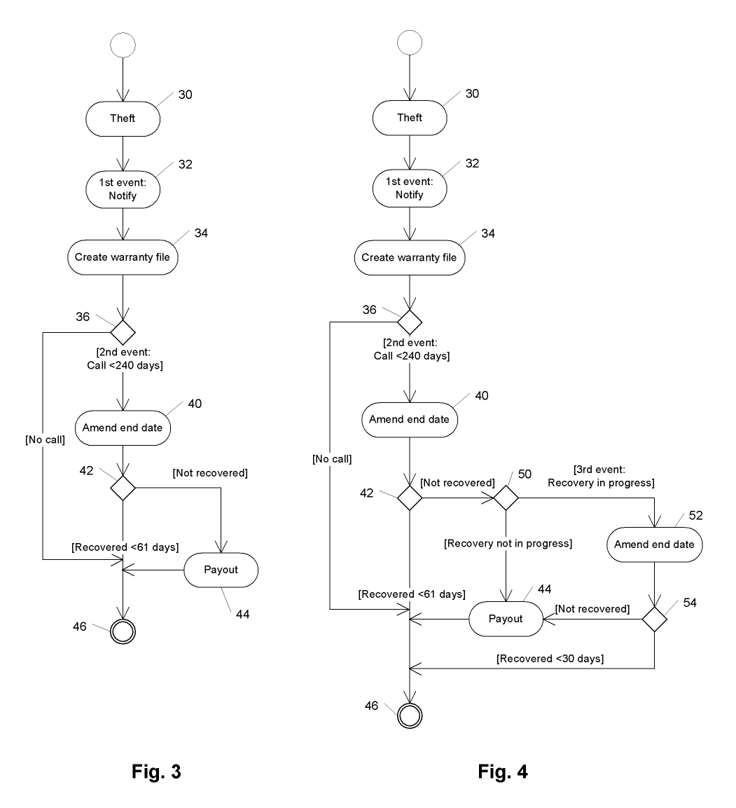

FIG. 3 is a functional flow diagram illustrating the flow process of the system. Following the theft 30 of a laptop, which is defined as the 1^{st} event, the monitoring centre is notified 32 thereof. Ideally, the theft is reported as rapidly as possible following the theft. Notification may alternatively be defined as the 1^{st} event. The monitoring centre creates 34 a warranty file. Following this is a period of waiting 36, where the system is waiting for the laptop to call in, which is denoted here as the 2^{nd} event. There is generally little control over this, because it depends on whether the thief connects the laptop to the internet or not, or whether the laptop is able to communicate with some other means such as via SMS over a cellular telephone network. If the laptop makes a successful call within a predetermined period of time, such as 240 days, the warranty end date is amended, in step 40, to 60 days hence, which usually allows more than sufficient time for the majority of laptops to be recovered. At decision point 42, if the laptop is not recovered prior to the amended end date, a payout 44 is made and then the process ends 46. If at point 42 the recovery is successful, the process ends 46 without a payout.

If the 2^{nd} event, a first call from the laptop, does not occur at point 36 within the predetermined time period of 240 days, then recovery cannot be attempted, no payment is due and the process ends 46.

In FIG. 4, an extended functional flow diagram is shown, which incorporates a 3^{rd} event. This process is the same as that shown in FIG. 3 up to point 50. This point is reached if the laptop is not recovered within 60 days of the 2^{nd} event, the first post-theft call. At this point, the warranty may be extended further if recovery of the laptop is in progress, which is denoted here as the 3^{rd} event. If at point 50 the recovery is in progress, the end date of the warranty is further extended in step 52 by 30 days. Following this, if at step 54 the recovery is not successful within the further 30 days, then a payout 44 is made and the process ends 46. If at 54 the laptop is recovered in these further 30 days, the process ends 46 without a payment.

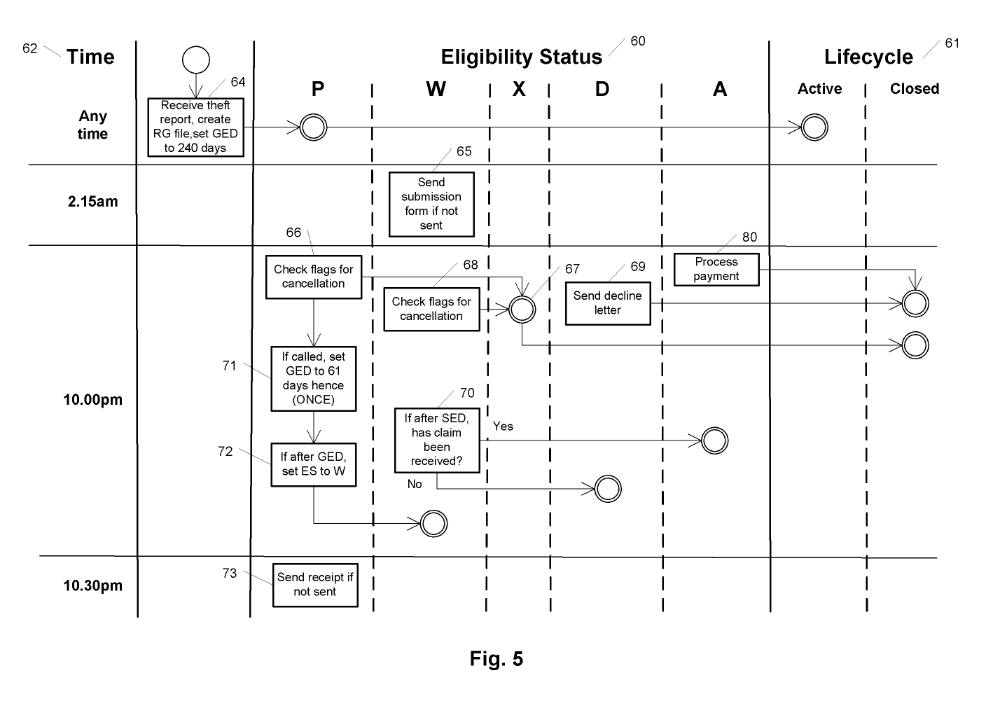

FIG. 5 shows the functions carried out by the warranty management system at the monitoring centre on a daily basis according to the flowchart in FIG. 3. In this embodiment, an initial guarantee period of 240 days is given, which is amended upon receiving the first post-theft call to expire 61 days after the call.

Each day, the relevant steps in a given row are carried out at the time specified in column 62, for all recovery guarantee (RG) files. Column 60 shows the eligibility status (ES) of the customer to a warranty payment, and it is split into five columns, each column representing an ES option. The ES options are P—Pending, W—Waiting, X—Cancelled, D—Declined and A—Approved. The column 61 defines the lifecycle status of the RG file, and is split into two further columns for each of the lifecycle statuses of active and closed.

At any time, the system can receive a theft report 64 and create a corresponding RG file, which is given a pending ES and an active lifecycle. The GED is set to 240 days.

At 2:15 am every day, the system checks for all RG files where the ES is Waiting, and sends out submission forms for each if forms have not already been sent, in step 65. The submission forms allow the customers to formally make a claim for warranty payment. They may be required to provide a valid proof of purchase as part of the submission.

At 10:00 pm, RG files that have a pending ES are checked 66 for cancellation flags. The warranty could be cancelled if the laptop has been found, if the licence term has expired, if the agent is over-installed or for other predefined reasons. If the file needs to be cancelled, its ES is changed to “X” 67. These RG files then have their lifecycle status set to closed. If the RG file does not need to be cancelled, then in step 71 the system checks for those pending RG files for which a first post-theft call has been received that day, and if so, the GED is amended to expire 61 days hence. This amendment occurs only once. The system then checks 72 for the pending RG files which have passed the GED, and sets the ES of these to waiting. The expiry of the GED without the laptop having been found signifies that a payment to the customer should be made. The ES is set to waiting, signifying a wait for the submission of correct forms from the customer.

Again at 10:00 pm, the system checks 68 the RG files with a waiting ES to see whether any need cancelling, which, if they do, they have their ES set to “X”. These RG files then have their lifecycle status set to closed.

Also at 10:00 pm, RG files with a declined ES are selected, and a letter stating that the warranty payment has been declined is sent out 69. These RG files then have their lifecycle status set to closed.

Still at 10:00 pm, RG files with an approved ES are selected, and a letter stating that the payment has been or will be processed is sent out 80. These RG files then have their lifecycle status set to closed.

At this time, for those RG files that have had a submission form previously sent out 65 and have since gone past the Submission Expiry Date (SED), a check 70 is made as to whether the submission form has been received from the customer. If it has, and it is acceptable (for example, it must be signed and/or accompanied with proof of purchase), the ES is set to “A”, signifying that payment has been approved. If it has not been received, or is not satisfactory, the ES is set to “D”. An SED may be defined as a predetermined number of days after the sending out of the submission form, such as 30 days.

At 10:30 pm, RG files with a pending ES have a receipt sent to the customer if one has not already been sent 73. The receipt indicates that the theft report has been received and a RG file has been set up.

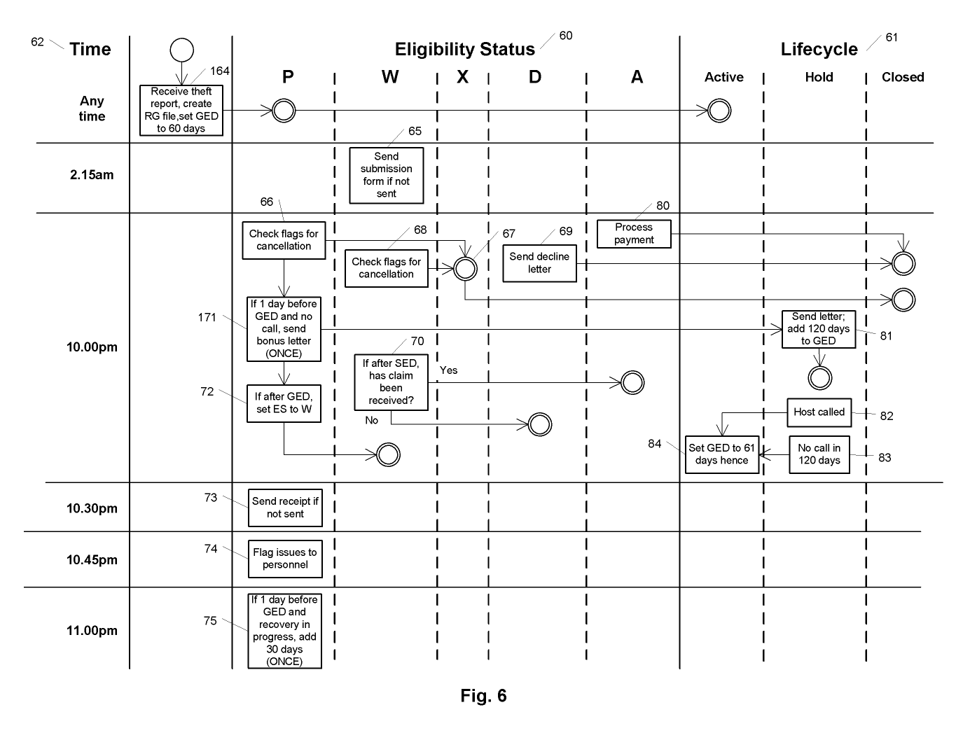

FIG. 6 shows the implementation of an alternate process carried out by the warranty management system at the monitoring centre on a daily basis. In this embodiment, an initial guarantee period of 60 days is given, which is then extended by 120 days and then a further 61 days.

Each day, the steps in a given row are carried out at the time specified in column 62, where relevant, for all recovery guarantee (RG) files. Column 60 shows the eligibility status (ES) of the customer to a warranty payment, and it is split into five columns, each column representing an ES. The ES options are P—Pending, W—Waiting, X—Cancelled, D—Declined and A—Approved. The column 61 defines the lifecycle status of the RG file, and is split into three further columns for each of the lifecycle statuses of active, hold and closed.

At any time, the system can receive a theft report 164 and create a corresponding RG file, which is given a pending ES and an active lifecycle. The GED is set to 60 days.

At 2:15 am every day, the system checks for all RG files with a waiting ES, and sends out submission forms for each if forms have not already been sent, in step 65. The submission forms allow the customers to formally make a claim for warranty payment.

At 10:00 pm, RG files that have a pending ES are checked 66 for cancellation flags. The warranty could be cancelled if the customer has found the laptop, if the licence term has expired, if the agent is over-installed or for other predefined reasons. If the file needs to be cancelled, its ES is changed to “X” 67. These RG files then have their lifecycle status set to closed. If the RG file does not need to be cancelled, then in step 171 the system checks for those pending RG files for which a first post-theft call has not been received and that expire the following day. Such files have 120 days added to their guarantee expiry date (GED) in step 81 and have their lifecycle status set to Hold. A bonus letter is sent to the customer. The system then checks 72 for the pending RG files which have passed the GED, and sets the ES of these to waiting. The expiry of the GED without the laptop having been found signifies that a payment to the customer should be made. The ES is set to waiting, signifying a wait for the submission of correct forms from the customer.

Again at 10:00 pm, the system checks 68 the RG files with a waiting ES to see whether any need cancelling, which, if they do, they have their ES set to “X”. These RG files then have their lifecycle status set to closed.

Also at 10:00 pm, RG files with a declined ES are selected, and a letter stating that the warranty payment has been declined is sent out 69. These RG files then have their lifecycle status set to closed.

Still at 10:00 pm, RG files with an approved ES are selected, and a letter stating that the payment has been or will be processed is sent out 80. These RG files then have their lifecycle status set to closed.

Once more at 10:00 pm, the RG files with a lifecycle status of Hold are checked to see whether the corresponding laptops have made their first post-theft report 82. If so, the lifecycle status is changed to Active and the GED is set to expire 61 days later in step 84. If the laptops corresponding to RG files with a Hold lifecycle have not called in within 120 days of the lifecycles being put on hold 83, then the lifecycle status is changed to Active and the GED is set to expire 61 days later in step 84.

At this time, for those RG files that have had a submission form previously sent out 65 and have since gone past the Submission Expiry Date (SED), a check 70 is made as to whether the submission form has been received from the customer. If it has, and it is acceptable (for example, it must be signed and/or accompanied with proof of purchase), the ES is set to “A”, signifying that payment has been approved. If it has not been received, or is not satisfactory, the ES is set to “D”. An SED may be defined as a predetermined number of days after the sending out of the submission form, such as 30 days.

At 10:30 pm, RG files with a pending ES have a receipt sent to the customer if one has not already been sent 73. The receipt indicates that the theft report has been received and a RG file has been set up.

At 10:45 pm, any pending RG files for which there are issues are flagged for administrative attention 74.

At 11:00 pm, pending RG files which are due to expire the following day, but for which recovery is still in progress, have 30 days added to their GED. This step only occurs once for each laptop stolen.

### Alternatives and Variations

Times and durations can be altered to suit different embodiments. Steps can be carried out in a different order. Some steps can be omitted and others included. Different conditions can be used for defining the warranty and the variations in its duration. Letters may be sent out by mail or email to the customer to provide notification of the changes in status and/or expiry date of the warranty. Instead of letters, recorded messages may be sent to the customers via phone. An implementation is possible without the need for a separate lifecycle status.

Warranties may be invalidated if notification of the theft is not made within a certain time period following the theft. The warranty amount may be made variable, depending on some conditions. For example, delaying notification could reduce the likelihood of recovery and it would be reasonable to reduce the payout in such circumstances.

Instead of the expiry date of the warranty being amended to end after a fixed duration following a given event, the duration of the amendment may be made dependent upon the time period between a first event and a second event. For example, if a laptop first calls in soon after a theft, a longer amended period may be given than if the laptop first calls in a long time after the theft.

The disclosed subject matter can be applied to other types of warranty where a variable term is required. It can be envisaged that this system may be applicable to healthcare industry. For example, a warranty may be given that an operation is successful and remains successful for a certain period of time, but only if the operation is commenced within a certain time period of notifying a doctor of a medical condition.

Except where indicated otherwise, all of the steps and tasks described herein may be performed and fully automated by a computer system, and may be embodied in software code modules executed by one or more general purpose computers. The code modules may be stored in any type of computer-readable medium or other computer storage device. Some or all of the methods may alternatively be embodied in specialized computer hardware. The computer system may, in some cases, be composed of multiple distinct computers or computing devices (e.g., physical servers, workstations, storage arrays, etc,) that communicate and interoperate over a network to perform the described functions. Each such computing device typically includes a processor (or multiple processors) that executes program instructions stored in a memory or other computer-readable medium. The results of the disclosed methods may be persistently stored by transforming physical storage devices, such as solid state memory chips and/or magnetic disks, into a different state.

The present description is of the best presently contemplated mode of carrying out the subject matter disclosed and claimed herein. The description is made for the purpose of illustrating the general principles of the subject matter and not be taken in a limiting sense; the claimed subject matter can find utility in a variety of implementations without departing from the scope and spirit of the invention made, as will be apparent to those of skill in the art from an understanding of the principles that underlie the invention.

We claim:

1. A system for managing a plurality of warranties, comprising:
a computer system comprising an interface for connection to a communications network, a processor and a memory, said computer system being connected to a communications network and configured to:
a. receive a first notification representing a first event;
b. define an expiry date of a warranty based on the occurrence of said first event;
c. receive a second notification representing a second event; and,
d. conditionally redefine the expiry date based on the occurrence of said second event.

2. The system according to claim 1, wherein the computer system is configured to define said expiry date based on the time or date of occurrence of the first event.

3. The system according to claim 2, wherein said expiry date is a first predetermined period of time after the occurrence of the first event.

4. The system according to claim 1, wherein the computer system is configured to redefine said expiry date based on the time or date of occurrence of the second event.

5. The system according to claim 4, wherein said redefined expiry date is a second predetermined period of time after the occurrence of the second event.

6. The system according to claim 5, wherein the second predetermined period of time depends on the first predetermined period of time.

7. The system according to claim 1, wherein said first notification is of a theft or loss.

8. The system according to claim 7, further configured to initiate a payment after the redefined expiry date if the theft or loss has not been resolved.

9. The system according to claim 7, wherein said theft or loss is of an electronic device.

10. The system according to claim 1, wherein said computer system is configured to receive said second notification automatically from an electronic device.

11. The system according to claim 1, wherein the computer system is further configured to:
receive a third notification indicating the occurrence of a third event;
conditionally adjust the expiry date based on the occurrence of said third event.

12. The system according to claim 11, wherein the computer system is configured to adjust said expiry date based on the time or date of occurrence of the third event.

13. The system according to claim 12, wherein said adjusted expiry date is a third predetermined period of time after the occurrence of the third event.

14. The system according to claim 1, further configured to automatically inform a user of a defining or redefining of an expiry date.

15. A computer system implemented method for managing a plurality of warranties, comprising:
a. receiving a first notification representing a first event;
b. defining an expiry date of a warranty based on the occurrence of said first event;
c. receiving a second notification representing a second event; and,
d. conditionally redefining the expiry date based on the occurrence of said second event.

16. A computer readable medium which stores program code that instructs a computer system to perform a method that comprises:
a. receiving a first notification representing a first event;
b. defining an expiry date of a warranty based on the occurrence of said first event;
c. receiving a second notification representing a second event; and,
d. conditionally redefining the expiry date based on the occurrence of said second event.

17. A warranty management system, comprising:
an electronic data repository that stores warranty information for each of a plurality of devices that are capable of communicating over a network, said warranty information pertaining to variable-length warranties that apply to device theft; and
a computer system programmed to receive communications from said devices, and to update the warranty information in the electronic data repository in response to said communications, said computer system being responsive to a communication from a device that has been reported stolen by adjusting a warranty expiration date for said device.
